(19) United States
(12) Patent Application Publication
(10) Pub. No.: US 2015/0120035 A1
(43) Pub. Date: Apr. 30, 2015

(54) Systems and Methods for Linking Trace Information with Sensor Data

(71) Applicant: Infineon Technologies AG, Neubiberg (DE)

(72) Inventor: Albrecht Mayer, Deisenhofen (DE)

(73) Assignee: Infineon Technologies AG, Neubiberg (DE)

(21) Appl. No.: 14/063,070

(22) Filed: Oct. 25, 2013

(51) Int. Cl. G05B 19/18

(52) U.S. Cl. CPC G05B 19/18
USPC 700/174

(57) ABSTRACT

A trace correlation system includes a data source, a controller, a probe component, and a tool. The data source is configured to provide raw data. The controller is configured to receive the raw data and generate trace information in response to the raw data. The probe component is configured to generate a data record from the raw data. The tool is configured to link the data record with the trace information.

### BACKGROUND

Electronic and/or computer systems often use sensors generated data or information during operation. The various sensors typically present in such systems generate data which and then the systems operate in response to the data. In some situations, such as for systems under development, the information is correlated to facilitate development.

Typical interfaces used by sensor systems are for relatively low amounts of data or information. Such low rate interfaces are suitable and cost effective for exchanging sensor and system information. However, the data generated by sensors and the number of sensors present in systems is increasing. As a result, low rate interfaces may be unsuitable to meet the ever increasing data rate needs. Additionally, the increasing amounts and rates of information can make correlation of the information and using the information even more difficult.

### BRIEF DESCRIPTION OF THE DRAWINGS

FIG. 1 is a block diagram illustrating a trace correlation sensor system.

FIG. 2 is a block diagram illustrating a trace correlation sensor system.

FIG. 3 is another diagram illustrating the trace correlation sensor system wherein recorded data is utilized.

FIG. 4 is a flow diagram illustrating a method of operating a trace correlation sensor system.

### DETAILED DESCRIPTION

The present invention will now be described with reference to the attached drawing figures, wherein like reference numerals are used to refer to like elements throughout, and wherein the illustrated structures and devices are not necessarily drawn to scale.

Systems and methods are disclosed that facilitate correlation of large data streams and trace information for sensor based systems.

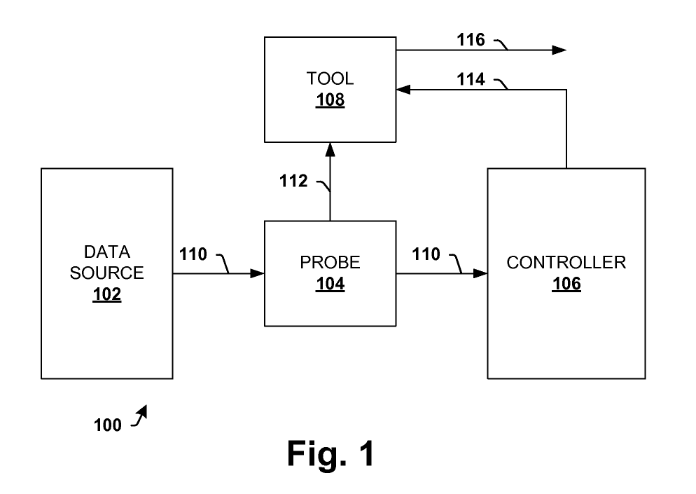

FIG. 1 is a block diagram illustrating a trace correlation sensor system 100. The system 100 provides linked information with relatively lower resources than other systems.

Systems, such as automotive systems and/or advanced driver assistance systems (ADAS), perform a variety of operations including driving assist, parking assist, object detection, collisions avoidance and the like. During development, raw data is recorded from sensors and the operations are performed in response to data from sensors. The results are then evaluated to identify deficiencies or enhancements needed in the operations. Then, the operations can be modified to correct the deficiencies and make the enhancements. For example, an operation for detecting pedestrians is evaluated and a deficiency is noted that the operation identifies 3 pedestrians when only 2 were present in video from the raw data. A second run or test with the modified operation can then be performed to verify proper results or identify deficiencies. The previously obtained sensor data can be reutilized in the second or subsequent runs.

The system 100 includes a data source 102, a probe 104, a controller 106 and a tool 108. The data source 102 is configured to generate raw data 110, which is provided to the controller 106. The data source 102 can include, for example, radar sensors, video sensors, and the like. In another example, the data source 102 provides previously recorded information as the raw data 110.

The raw data 110 is generally a relatively large amount of data and is provided at high data rates. In one example, the data 110 is provided at gigabit data rates. Further, the raw data 110 can include, for example, video information, audio information, radar information, and the like.

The controller 106 receives the raw data 110 and is configured to perform one or more algorithms or operations in response to the raw data. In one example, the operations include detecting pedestrians, other automobiles, potential collisions, and the like. The performance of the operations is traced by the controller 106 to generate trace information 114. The trace information 114 includes information about the performance of the operations in response to the raw data 110 and a signature or correlation information. In one example, the trace information includes variable values, memory locations and contents, executed instructions, and the like. In another example, the trace information 114 includes number of pedestrians detected, size and location of detected objects, and the like.

The signature is included with the trace information 114 and provides a mechanism with which to later link or correlate the trace information to the raw data 110. In one example, the signature is a 32 bit CRC based on a block of data from the raw data 110. In another example, the signature is an XOR of a sample of a data block from the raw data 110. The data block is a block or unit of the raw data 110. For example, the data block can represent a video frame, line of video, a radar chirp, and the like.

The controller 106 is a processor based component that executes instructions and uses memory. In one example, the controller 106 is a system on chip (SOC) device.

The probe 104 obtains a data record 112 of the raw data 110. The data record 112 is substantially a copy version of the raw data 110 and essentially includes the information of the raw data. Thus, video information, radar information, and the like present in the raw data 110 are also provided in the data record. The probe 104, in one example, is a passive device that obtains the data record without disturbing the raw data 110 provided to the controller 106. In another example, the probe 104 is active and forwards a copy to the controller 106 as the raw data and a copy to the tool pod as the data record 112.

The tool 108 is configured to link the data record 112 with the trace information 114 and provide the linked information as linked output data 116. The output data 116 includes information from both the data record 112 and the trace information 114. The output data 116 can then be utilized by a tool or other component for analysis of the operations. For example, if the operations performed by the controller 106 include pedestrian detection, video information present in the output data 116 can be stored and analyzed to verify performance of the pedestrian detection.

The tool 108 links the data record 112 with the trace information 114 by using the signature present within the trace information 114. The signature identifies which blocks of the data record 112 to correlate with portions of the trace information 114.

In one example, the tool 108 stores the data record 112 and trace information 114 in separate locations. The data record 112 can also be stored in various portions, such as a video portion, a radar portion, and the like. Furthermore, the data record 112 can be provided to the data source 102 in order to use the data record 112 as the raw data 110 in subsequent runs. Thus, for example, the operations performed by the controller 106 can be adjusted and/or configured and reevaluated by reusing the data record 112 multiple times.

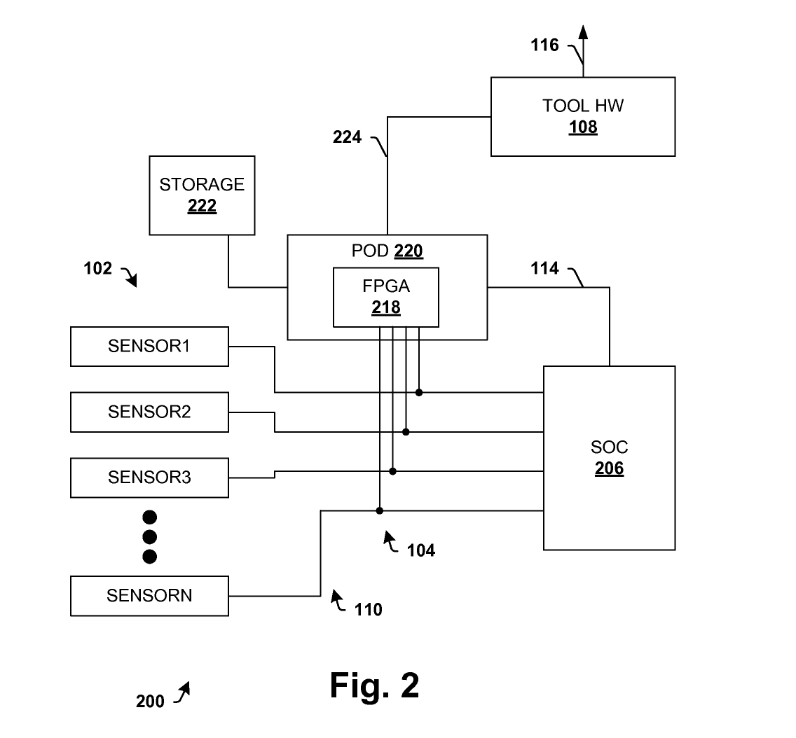

FIG. 2 is a block diagram illustrating a trace correlation sensor system 200. The system 200 correlates raw data with trace information and performs the correlation external to a controller or control unit. The system 200 is provided as a suitable example of the system 100 described above. For additional description of like numbered components, please reference the above description.

The system 200 includes a plurality of sensors 102, connection probes 104, a system on chip (SOC) controller 206, a pod 220 and tool hardware 108. The plurality of sensors 102 act as a data source and collectively provide raw data 110 to the SOC 206. Each sensor is shown, in this example, as providing a separate data signal to the SOC 206. The separate signals are carried on a parallel interface, in this example. These separate data signals comprise the raw data 110. The raw data 110 includes, for example, video information, audio information, radar information, and the like.

The plurality of sensors 102 measure or sense characteristics of the surrounding environment. For example, video type sensors measure or capture images. Audio type sensors measure various sounds proximate to the sensor. Radar type sensors measure radar waves proximate to the sensor. It is appreciated that other types of sensors are contemplated.

The sensors 102 are controlled by the SOC 206. The SOC 206 can activate, deactivate, request measurements, and the like from the sensors 102. The sensors 102 provide a relatively large amount of data at a high bandwidth to the SOC 206 as the raw data 110. In one example, the raw data 110 is provided at gigabit data rates. In another example, the raw data 110 is provided at mega bit data rates. The raw data 110 is comprised of independent serial data streams recorded in parallel by the sensors 102.

The SOC 206 receives the raw data 110 and performs one or more operations in response to the raw data 110. The operations include, for example, detecting pedestrians, detecting other automobiles, potential collisions, and the like. Trace information 114 is generated based on the performance of the operations and includes a signature based on the raw data 110. The trace information 114 includes, for example, variable values, memory locations, executed instructions, and the like. Further, the trace information 114, in another example, includes information from varied levels of detail. For example, the trace information 114 includes pedestrians detected, object location, and the like.

As stated above, the signature is based on or generated from the raw data 110 and facilitates later correlating or linking the data with the trace information 114. In one example, the signature is an XOR of a data block from the raw data.

The connection probes 104 are proximate or in contact with lines connecting the sensors 102 to the SOC 206. The probes 104 obtain a data record that substantially includes the information from the raw data 102. As shown, the probes 104 obtain independent serial data streams recorded in parallel, and referred to as a data record.

A field programmable gate array (FPGA) 218 receives obtained independents serial data streams, in parallel, via an interface from the probes 104. The FPGA also receives the traces information 114 via a third interface coupling the SOC 206 and the tool pod 108.

The pod 220 converts the received data record, having multiple streams, and the trace information 114 into a high speed/rate signal 224.

The pod 220 is also configured to store the data record and the trace information 114 in a storage element 222. The stored information can be provided and linked on demand. Additionally, the stored information can be segregated according to type of data. For example, the stored information can be separated into video information, radar information, and the like. Once stored, the information can be accessed by type.

The data from the probes 104 and the trace information 114 are generally not linked or correlated at the pod 220, but are converted for the high speed transmission to an external component, such as the tool 108. An alternative implementation is that the data from the probes 104 and the trace information 114 are linked at the pod 220.

The tool 108 generally receives the high speed signal 224 and links the data record with the trace information 114 by using the signature from the trace information 114. The linked information is provided as output data 116, which is provided via a high speed interface in one example.

In one example, the tool hardware 108 is configured to analyze the trace information and the data record to evaluate performance of the operations by the SOC 206. The tool hardware 108 identifies and/or corrects performance errors from the analysis. The tool hardware 108 is operable to retest the modified operations by reusing the same raw data and/or new obtained raw data. It is noted that the linking and analysis can be done off line and/or separate from the sensors 102, the SOC 206, and the POD 220.

A computer or tool computer can be used as or with the tool hardware 108. For example, for object detection operations, the computer can show a specific video frame on a screen and draw boxes around detected objects having coordinates that are part of the trace information linked to the specific video frame. In this example, a user can review the detected objects and determine whether the object detection operations performed properly. As another example, the tool computer can perform a more sophisticated algorithm to evaluate performance of the object detection operations.

It is noted that the system 200 processes the output data without the SOC 206 being required to forward or transmit the raw data. Thus, the SOC 206 only needs suitable hardware to perform the operations and generate the trace information 114. The SOC 206 is free from linking the trace information with the raw data.

It is also noted that the pod 220 and the SOC can be configured on a single chip separate from the other components in the system 200. This configuration requires limited circuitry and complexity and offloads the linking and analysis functionality performed by the tool hardware 108.

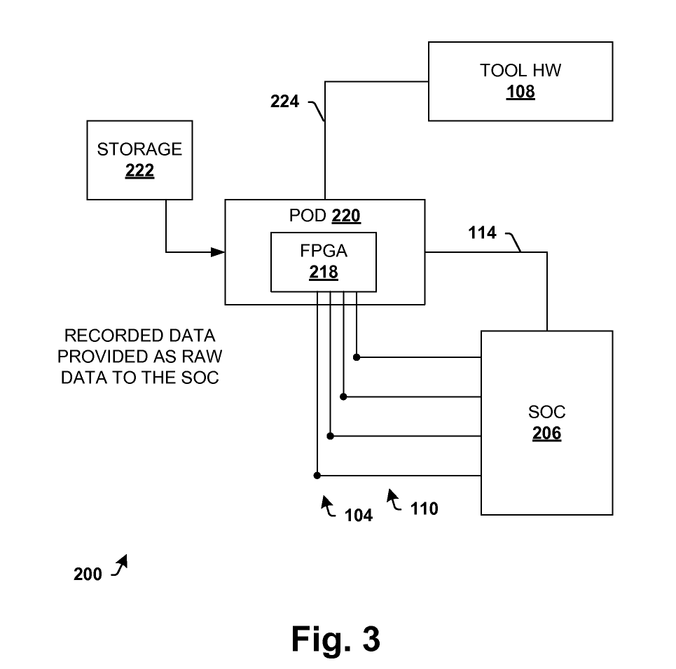

FIG. 3 is another diagram illustrating the trace correlation sensor system 200 wherein recorded data is utilized. The data record has been previously stored in the storage element 222 and is utilized to generate new trace information instead of data from sensors. Typically, the tool hardware 220 initiates a retest or reuse of the recorded data for a second or later run to test performance of the operations and/or verify improvements/corrections.

Here, the probes 104 are configured to apply parallel information signals to lines connected to the SOC 206. The pod 220 extracts the stored data record from the storage element and creates the parallel signals carried to the probes 104.

The SOC 206 receives the raw data and processes the raw data and generates the trace information 114 as if the raw data was from the sensors 102. As a result, test scenarios can be repeated a selected number of times in order to improve the operations performed by the SOC 206.

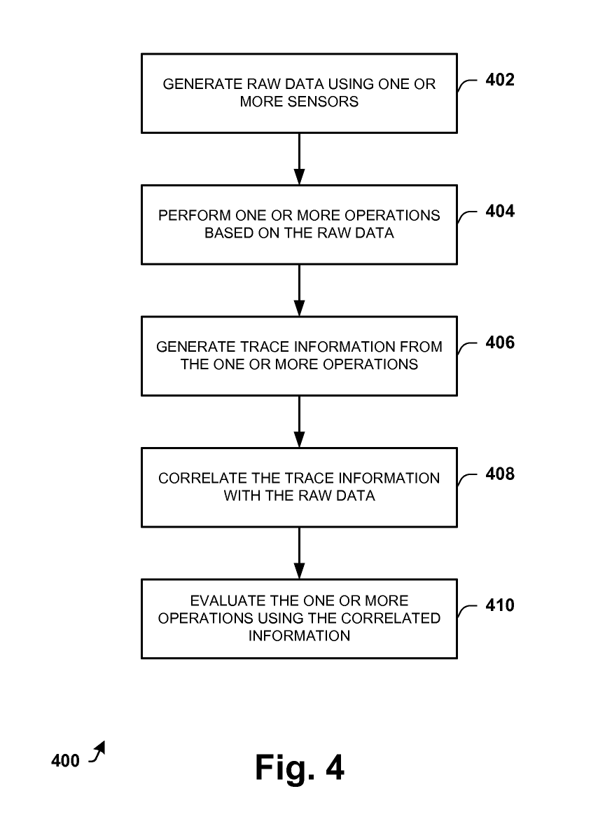

FIG. 4 is a flow diagram illustrating a method 400 of operating a trace correlation sensor system. The method 400 correlates trace information with raw data external to a controller that performs operations using the raw data.

Systems, such as automotive systems, perform a variety of operations including driving assist, parking assist, object detection, collisions avoidance and the like. During development, these operations are performed in response to sensor measurements or data and the results are evaluated to identify deficiencies or enhancements needed in the operations. Then, the operations can be modified to correct the deficiencies and make the enhancements.

The method 400 can be utilized with such systems to evaluate the operations without a controller linking the results with the data and/or transferring the data to an external tool.

The method begins at block 402, where raw data is generated using one or more sensors. The sensors include video type sensors or cameras, radar sensors, audio sensors, proximity sensors, and the like. The raw data includes video data, radar data, audio data, and the like. The raw data is generated at a relatively high rate. In one example, the raw data is generated at gigabits per second or faster. In another example, the raw data is generated at megabits per second or faster.

One or more operations are performed at block 404. The one or more operations can include driving assist, parking assist, object detection, collision avoidance, and the like. These are performed using the generated raw data and are performed at a controller, such as a silicon on chip controller.

Trace information is generated at block 406 from the performed one or more operations. The trace information includes information related to performance of the one or more operations and is generated by the controller. For example, the trace information can include environmental variables, detected objects, and the like. The trace information also includes a signature generated from the raw data. The signature is later used to correlate the data with the trace information. The signature can be provided as a separate signal from the trace information or as an integrated signal with the trace information.

The signature is obtained, in one example, by computing a CRC per block or frame of data. In another example, the signature includes a time stamp derived from the raw data.

It is noted that the controller is not required to combine the raw data with the trace information or provide the high data rate raw data as an output.

The trace information is linked with the raw data at block 408. A tool computer or tool hardware is typically used to perform the linking. The signature with the trace information is used for the linking of the information from both sources.

In one example, the trace information and the raw data are stored for later reuse and retrieval. Once stored, the stored data can be used for subsequent developmental runs and/or transfer to external components or tools.

In another example, the trace information and the raw data are converted to a high speed data stream and provided to an external component or tool via a high speed interface.

The raw data is provided by a suitable mechanism. In one example, probes are used to passively obtain the data from the raw data sent to the controller.

The linked information is used to evaluate performance of the one or more operations at block 410. The linked information, which includes the raw data and the trace information linked with each other, is used to evaluate the one or more operations. In one example, the linked information is evaluated to determine if the operation identified the proper number of pedestrians in a test run.

In one example, the evaluation is performed by a developer in conjunction with a tool computer external to the tool pod and the controller. The developer evaluates the linked information and may implement changes to the one or more operations. For example, the developer may alter an algorithm used in a detection operation. It is however also possible that the human developer is assisted or even replaced by an automatic, computer based optimization loop for the 404 operations.

As another example, a tool computer identifies and displays a specific video frame on the screen and draws boxes around the detected objects whose coordinates are part of the trace information linked to this video frame.

It is appreciated that the above methods and variations thereof can be combined and utilized interchangeably.

While the above methods are is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases.

It is appreciated that the claimed subject matter may be implemented as a method, apparatus, or article of manufacture using standard programming and/or engineering techniques to produce software, firmware, hardware, or any combination thereof to control a computer to implement the disclosed subject matter (e.g., the systems shown above, are non-limiting examples of system that may be used to implement methods). The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

A trace correlation system includes a data source, a controller, a probe component, and a tool pod. The data source is configured to provide raw data. The controller is configured to receive the raw data and generate trace information in response to the raw data. The probe component is configured to generate a data record from the raw data. The tool pod is configured to link the data record with the trace information.

Another trace correlation system includes a probe component, a controller, a tool pod, and tool hardware. The probe component is configured to obtain a data record from raw data. The controller is configured to receive the raw data, to perform operations in response to the raw data, and to generate trace information in response to the raw data and the performed operations. The tool pod is configured to link the data record with the trace information in order to generate a linked output signal. The tool hardware component is configured to receive the linked output signal and to evaluate the performance of the operations by the controller.

A method of linking trace information with raw data is disclosed. The raw data is generated using one or more sensors. One or more operations are performed at a controller in response to the raw data. Trace information is generated from the performed one or more operations. The trace information is linked with the raw data at a tool pod external to the controller.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A trace correlation system comprising:
a data source configured to provide raw data;
a controller configured to receive the raw data and generate trace information in response to the raw data;
a probe component configured to generate a data record from the raw data; and
a tool configured to link the data record with the trace information.

2. The system of claim 1, wherein the data source includes a radar sensor that provides radar information as part of the raw data.

3. The system of claim 1, wherein the data source includes a video sensor that provides video information as part of the raw data.

4. The system of claim 1, wherein the data source includes a plurality of video and radar sensors.

5. The system of claim 1, wherein the raw data comprises a previously generated data record.

6. The system of claim 1, wherein the controller performs operations in response to the raw data.

7. The system of claim 6, wherein the operations include detection of objects.

8. The system of claim 6, wherein the trace information includes results from the operations.

9. The system of claim 8, wherein the results include number and size of detected objects.

10. The system of claim 8, wherein the results include executed instructions and variable values.

11. The system of claim 1, wherein the controller is configured to generate a signature for linking the trace information and to include the signature with the trace information.

12. The system of claim 11, wherein the tool is configured to link the data record with the trace information using the signature from the trace information.

13. The system of claim 1, wherein the tool is configured to provide an output signal having the data record linked with the trace information.

14. A trace correlation system comprising:
a probe component configured to obtain a data record from raw data;
a controller configured to receive the raw data, to perform operations in response to the raw data, and to generate trace information in response to the raw data and based on the performed operations;
a tool configured to link the data record with the trace information in order to generate a linked output signal, wherein the linked output signal is utilized to evaluate the performance of the operations by the controller.

15. The system of claim 14, further comprising a sensor configured to provide the raw data.

16. The system of claim 14, wherein the tool facilitates modification of algorithms within the operations based on its evaluation of the linked output signal.

17. The system of claim 16, wherein the probe component is configured to provide previously recorded data as the raw data.

18. The system of claim 14, wherein the controller is configured generate a signature and provide the signature with the trace information.

19. The system of claim 18, wherein the tool is configured to utilize the signature to link the data record with the trace information.

20. A method of linking trace information with raw data, the method comprising:
generating raw data using one or more sensors;
performing one or more operations at a controller in response to the raw data;
generating trace information from the performed one or more operations; and
linking the trace information with the raw data external to the controller.

21. The method of claim 20, further comprising evaluating performance of the operations from the linked trace information and raw data.

22. The method of claim 20, wherein generating raw data comprises generating a video stream.

23. The method of claim 20, wherein generating the trace information includes generating a signature with the trace information.

24. The method of claim 23, wherein the signature is based on the raw data.
